(19) United States
(12) Patent Application Publication
(10) Pub. No.: US 2022/0193686 A1
(43) Pub. Date: Jun. 23, 2022

(54) Method For Conditioning Plant Seeds For Milling, In Particular For Influencing The Elasticity Of The Plant Seeds, And System For milling Plant Seeds

(71) Applicants: Elea Vertriebs-Und Vermarktungsgesellschaft MBH, Quakenbruck (DE); Mühlenchemie GmbH & Co. KG, Ahrensburg (DE)

(72) Inventors: Volker Heinz, Quakenbruck (DE); Lutz Popper, Hamburg (DE); Stefan Toepfl, Quakenbruck (DE)

(21) Appl. No.: 17/605,449

(22) PCT Filed: Apr. 22, 2020
(86) PCT No.: PCT/EP2020/061117

§ 371 Date: Oct. 21, 2021

(30) Foreign Application Priority Data
Apr. 23, 2019 (DE) 10 2019 205 793.4

(51) Int. Cl. B02B 1/04; B02B 5/02; B02C 9/04; B02C 23/10

(52) U.S. Cl. CPC B02B 1/04; B02C 23/10; B02C 9/04; B02B 5/02

(57) ABSTRACT

The present invention relates to a method for conditioning plant seeds (3) for disintegration and to a system (1) for disintegration of plant seeds (3), comprising a conditioning system (2) for conditioning the plant seeds (3), a disintegration device (4) for disintegration of the conditioned plant seeds (3), and a separating device (5) for separating different fractions of the disintegrated plant seeds. In order to provide a method and a device which facilitate the subsequent disintegration of the plant seeds and positively influence the behavior of the plant seeds during the disintegration process, according to the invention, the plant seeds (3) are exposed to an electrical field, or the conditioning system (2) has a capacitor (6) for generating an electrical field that acts on the plant seeds (3).

The present invention relates to a method for conditioning plant seeds for disintegration (i.e. reduction to smaller pieces), in particular for influencing the elasticity of the plant seeds and/or for improving the wettability and/or thorough moistening of the plant seeds compared to untreated, non-conditioned plant seeds.

The present invention further relates to a system for disintegration of plant seeds, comprising: a conditioning system for conditioning the plant seeds for disintegration, a disintegration device for disintegration of the conditioned plant seeds, and a separating device for separating different fractions of the disintegrated plant seeds.

For example, for flour production, the endosperm of a grain must be separated from the bran (seed coat, aleurone layer, and germ).

In order to separate the coat from the hard kernel, the cereals are conditioned by slightly moistening (wetting) the coat so that it becomes tougher and can be separated from the kernel with as little fragments as possible.

Below, the processing of cereals as an example of plant seeds will be discussed by way of example. The grinding of wheat plays a superior part as 700 to 750 millions of tons of wheat must be processed annually worldwide.

From a wheat miller's point of view, the grain is composed of the endosperm, the germ and the surrounding bran layer. Biologically, the structure is more complicated. The bran consists of many layers which are supposed to prevent, in terms of developmental biology, the access of harmful organisms to the endosperm. In particular the seed coat (testa) is hydrophobic, that means it also prevents the penetration of water. The aleurone layer which is connected with the endosperm is located underneath the bran. The cells of the endosperm are formed 26 in the aleurone layer. Nevertheless, the aleurone layer is part of the bran from the millers' point of view. While it is rich in proteins, these do not make any positive contribution to the baking capacity of a flour due to their structure. It moreover contains many minerals which would lead to an undesired increase of the mineral content in the flour. In many countries, and also in Germany, flours are classified into various flour types according to their mineral content. The miller here usually strives for a high yield of flours with low mineral contents because they can be better merchandised thanks to their higher baking capacity and lighter color.

The separation of the bran is improved by slightly moistening (wetting) the surface since the toughness of the bran increases thereby and it thus does not fall apart, during the grinding process, into small pieces so easily which are difficult to separate from the remaining flour.

Moreover, in flour production, it is intended to also slightly moisten the endosperm since this improves its grinding properties, and the moisture loss of the flour to be expected during the grinding process is compensated. So, wetting also serves to adjust the water content of the flour and thus has a great influence on the quality and cost efficiency of the end product.

For this complex task, in most cases a two-stage wetting has been applied up to now. In a first step, approximately 2 to 5% of water is sprayed onto the cereals in a continuous swirl mixer and is uniformly distributed across the grain's surface. Subsequently, the cereals must temper for 8 to 36 hours to permit the water to penetrate into the grain. The actual tempering time depends on the quality of the grain. Large grains take more time than small ones, hard ones take more time than soft ones.

Here, the water does not penetrate across a broad front, but initially only into cracks and fissures (capillaries) which go deep into the endosperm [Münzing, K., 2013, “Neue Erkenntnisse über Netzungs-und Aufmischeffekt bei Mahlweizen”, Mühle Mischfutter 150(14), 246]. This process is completed after about 1 hour. Only thereafter, a gradual spreading of the water in the complete grain takes place. Directly before the actual grinding, the coat is wetted with the aim of imparting higher toughness to the outer layers.

A mill therefore has to provide additional storage capacities in the order of a daily production which means a considerable space demand and can be a limiting factor when an extension is desired.

Prior art includes mechanical methods which are to improve the distribution of the water on the surface of the grains and the penetration into the grains. Such a method which is based on vibration is described in DE 41 27 290 A1.

It is also known, for example from WO 03/024242 A1, to add salts or enzymes to the wetting water which is to facilitate the detachment of the bran.

There are similar problems in the conditioning of other plant seeds for disintegration. Plant seeds in the sense of the present invention include in particular cereal grains and pulse crop, that means cereals such as wheat, rye, barley, oats, triticales and corn, rice, millet, and also beans, peas, chickpeas, lentils, soya beans that belong to the legumes (pulse crop).

Disintegration (i.e. reduction to smaller pieces) is to be understood as the splitting up of solid substances under the action of mechanical forces. Disintegration can be accomplished, for example, by striking, splitting, grating, squeezing, breaking, pressure, shearing, impact. Peeling, that means breaking up or removing the seed coat, is also disintegration in the sense of this invention.

In view of the above-mentioned problems, it is an object of the present invention to provide a method and a device for conditioning plant seeds which facilitate the disintegration of the plant seeds and positively influence the behavior of the plant seeds during the disintegration process.

The present invention achieves this object by a method for conditioning plant seeds for disintegration, characterized in that the plant seeds are exposed to an electrical field.

The system for disintegration of plant seeds mentioned in the beginning achieves this object by the conditioning system having a capacitor for generating an electrical field that acts on the plant seeds.

It surprisingly showed that the action of an electrical field on plant seeds quickly and easily modifies their structure and texture, in particular their elasticity, such that the plant seeds can be disintegrated particularly well. By the action of an electrical field, plant seeds, for example chickpeas, rice and soya beans, can be better peeled, i. e. the coat can be removed in a surprisingly easier way, nearly without any residue, and thus better than with untreated plant seeds. For example, it has been surprisingly found that plant seeds, for example dry grains, have a more elastic seed coat after the treatment with an electrical field, thus increasing the toughness of the seed coat and improving the disintegration properties. It has moreover been surprisingly found that plant seeds which are exposed to an electrical field can be better wetted and thoroughly moistened with a liquid. Wetting or wettability is the behavior of the plant seed surface in case of contact with liquids. A wetting that is preferably quick and complete is desired, where the liquid spreads on the surface and adheres to the surface. Moistening thoroughly is a distribution of the liquid in the complete plant seed, that means also in the inner endosperm. Where an improvement is mentioned, this means a comparison of the plant seeds conditioned according to the invention with correspondingly unconditioned plant seeds that have not been exposed to an electrical field.

The elasticity of a plant seed can be determined, for example, by means of a texture analyzer by means of the maximal compression force. With such a machine, the plant seed can be compressed at a constant speed of, for example, 1 mm/s, and a load-displacement curve can be plotted. For compression, an aluminum cylinder having a diameter of 15 mm under which the seed is placed with the seed fold facing downwards can be employed, for example. The texture of a plant seed can be determined, for example, by means of internationally acknowledged methods, such as the AACCI method 55-30.01. Here, the texture of a wheat grain, which has relevant effects on the grinding quality and on parameters, such as damaged starch, water absorption and gas production, is determined by determining the relative hardness in all wheat types by means of the determination of the particle size index by grinding and screening. The data obtained during screening are converted into a relative hardness using a table. The international method AACCI 55-31.01, too, can be employed to determine the texture of a wheat grain by industrially measuring the force required for disintegration of wheat grains. The single-kernel characterization system instrument is here calibrated to calculate the kernel texture according to the AACC method 39-70.02 (near-infrared method) or a modification of the method 55-30.01 using a cyclone sample mill (impeller type). This method can be applied, for example, for all wheat types and barley without coat. An improved wettability or thorough moistening shows, for example, in that either more liquid wets the plant coat or penetrates into the endosperm and is bound in the plant seed, or that a comparable amount of liquid more quickly wets the seed coat or penetrates into the endosperm in the conditioned plant seeds.

The invention can be further improved with the following further developments and advantageous embodiments which are each per se advantageous and can be combined with each other as desired.

When the plant seeds are exposed to an electrical field, the plant seeds can be electroporated, i. e. the cell membrane is temporarily (reversibly) or permanently (irreversibly) permeable. The applied electrical field can moreover cause a controlled cell disruption 3o wherein the degree of cell disruption is adjusted to a predetermined value. The applied electrical field can in particular be a non-thermally acting electrical field, wherein the upper energy limit is selected such that essentially no heating of the plant seeds in the sense of an Ohmic heating takes place.

In the treatment with or the application of the electrical field, an energy input of at least 1 kJ/kg into the plant seeds can be effected. An energy input in this order is well-suited to modify the texture and structure of the seeds and thus improve the elasticity or wettability/thorough moistening of the plant seeds. To optimize the energy input and prevent an energetically unnecessary overtreatment of the plant seeds, the energy input into the plant seeds can be 1 kJ/kg to 20 kJ/kg, preferably 8 kJ/kg to 12 kJ/kg into the plant seeds.

It furthermore showed that it is advantageous for the plant seeds to be exposed to an electrical field of 0.3 kV/cm to 10 kV/cm, preferably 2 kV/cm to 4 kV/cm. Such field strengths can be achieved with commercially available industrial capacitors and prevent the occurrence of undesired thermal effects leading to not intended product modifications.

The plant seeds can be particularly effectively conditioned by means of electric pulses, wherein the plant seeds are exposed to a pulsed electrical field. The system according to the invention can provide to this end, for example, a capacitor with at least two electrodes connected with a pulse generator as a voltage source. The capacitor and the electrodes can be part of an electroporator to treat the plant seeds with a pulsed electrical field. The electrical field, in particular the electric pulses, can be generated both by a direct contact of the capacitor or its electrodes with the plant seeds, and by fluids, wherein the plant seeds are completely or partially placed into the fluids. Here, different electrode shapes can be employed, for example plate, annular, grid, hollow or flow electrodes which can be arranged in many different ways, for example in parallel, coaxially, colinearly, conically or as an annular gap. As the pulse generator, a high-voltage pulse generator, for example a Marx generator, can be employed which generates electrical fields in the form of short pulses in a micro- to millisecond range of a high voltage in the kV range. Such high-voltage pulses cause an electroporation in the plant seeds to be conditioned, which in particular results in a permeabilization of the cell membrane and advantageously influences the structure and texture of the plant seeds in a particularly easy and non-thermal manner.

In the sense of time and energy optimization, the plant seeds can be softened with at least 10 electric pulses, preferably 10 to 200 electric pulses, and preferred 30 to 50 electric pulses.

According to a further embodiment, the elasticity of the plant seeds can be improved during conditioning compared to non-conditioned plant seeds. The elasticity can here in particular be adjusted to a certain elasticity range which is oriented towards the desired particle size or the degree of grinding or pulverization. For the particle size, for example, finely-ground flour has a particle size of <180 μm, so-called farina has a particle size of 300 to 1000 μm, and grist has a particle size of more than 1000 μm. The degree of fineness between flour and farina is referred to as coarse-grained flour and has a particle size of 180 to 300 μm. The degree of pulverization describes, in particular in cereals processing in the mill, how much flour can be manufactured from 100 kg of cereals. In Germany, for wheat one can describe, for example, statements on the degree of pulverization by the corresponding flour designations, for example the German DIN designations Type 405, Type 550, Type 1050 or whole-meal. Corresponding typifications also exist for baking grist or rye meal.

In a particularly preferred manner, the elasticity of the seed coat and/or the elasticity of the seed kernel, in particular the endosperm, can be modified during conditioning. The plant kernel is to be understood to be everything within the seed coat, including the endosperm and the embryo or germ. By the conditioning according to the invention, the elasticity of the seed coat can be adjusted such that the coat can be removed from the seed kernel easily and nearly without leaving any residues during disintegration. Simultaneously, the elasticity of the seed kernel can also be adjusted such that the peeled seed kernel is prepared for its further processing, e. g. further disintegration or retention as a whole. For example, the elasticity in cereals can be adjusted such that the elasticity of the bran is improved and the elasticity of the endosperm remains brittle without changing. This advantageously causes the more elastic and thus tougher bran to fall apart into fewer fragments during disintegration than the more brittle kernel, and the bran can thus be better separated from the ground endosperm.

According to a further embodiment, a moistening liquid can be added to the plant seeds before or while they are exposed to the electrical field. The conditioning system of the system according to the invention can to this end have, for example, a wetting device for moistening the plant seeds, for example in the form of spray nozzles, via which a moistening liquid is superficially applied to the plant seeds A moistening liquid such as water can be applied to the plant seeds, for example, in the order of 0.5 to 20%, preferably 2 to 5%.

The statement of % of the wetting water amount or moistening liquid refers to the unwetted cereals. So, if 1000 kg of wheat is to be wetted with 2%, 20 kg of water are required. However, for calculating the required amount of water, the overall mass is considered, of course. The command variable is the desired pulverization moisture taking into consideration the starting humidity. The formula for this is:

% Water addition=((100)*(target humidity−starting humidity))/(100−target humidity)

Example: 14% of starting humidity must be wetted with 2.99% to achieve 16.5% of final humidity.

It furthermore showed that the conditioning by means of electrical fields leads to an advantageous wetting and thorough moistening already with a relatively low amount of wetting liquid. For example, the mass ratio of moistening liquid to plant seeds during the treatment by means of an electrical field can be 1:1 to 20:1, preferably 1:1 to 10:1. The mass ratio is influenced on the one hand taking into consideration the desired water absorption, on the other hand by the design of the apparatus for electroporation and product conveyance. If for the conveyance through the treatment apparatus or the compensation of possible cavities during treatment, a higher water addition is required, a separation step for separating excess water can be subsequently accomplished.

The conditioning of the plant seeds with an electrical field facilitates, especially if an electroporation is performed, the adherence of the moistening liquid to the seed coat which significantly improves wetting. Moreover, the conditioning according to the invention accelerates the penetration of the liquid into the inner endosperm which significantly reduces the thorough moistening and the required tempering times which are typically 8 to 36 hours for cereals. The conditioning by means of the electrical fields thus not only provides a positive texture modification of the plant seeds, but also an improved wetting and thorough moistening and thus shorter tempering times.

Tempering time is the time required for water to penetrate into the interior of the plant seed, for example the grain. The system according to the invention has at least one tempering cell within its conditioning system. The electrodes of the capacitor can be part of the tempering cell, or they can be arranged upstream of the tempering cell, for example, directly in front of or within a conveyor or metering device for the transport of the plant seeds into the tempering 26 cell. The wetting device of the conditioning system can also be part of the tempering cell or be upstream of the electrodes or integrated in the electroporator.

According to a further embodiment, the plant seeds can be exposed to a predetermined pressure and/or a predetermined temperature. The exposition to a predetermined temperature or a predetermined pressure can be performed during the exposition to an electrical field, or else downstream of the electrical field, for example during the tempering time during which plant seeds conditioned with the electrical field dwell in a tempering cell. The pressure or temperature, respectively, can be selected, for example, such that certain enzymes which advantageously influence the texture of the plant seeds or accelerate the action of the wetting liquid are close to the optimal temperature (the temperature with the highest enzyme activity). To this end, the conditioning system can have a temperature and/or pressure controller, for example. By means of these controllers, the temperature or pressure in the electroporator and/or in the tempering cell can be adjusted to and maintained at a predetermined desired value, for example.

According to a further embodiment, enzymes can act on components of the plant seeds within the conditioning method according to the invention. It showed that, for example, endogenous enzymes are released by electroporation and can be optionally activated upon activation by the adjustment of a certain temperature, a certain pressure, or simply a certain tempering time. By the selection of the pH value or the polarity of the wetting liquid, the desired enzyme activity could also be positively influenced. It is also possible to add enzymes to the plant seeds during conditioning, for example during or after the exposition to an electrical field. It is, for example, conceivable to mix the enzymes with the wetting liquid which is then added to the plant seeds. Mainly with hemi-cellulolytic enzymes, a significant reduction of the required tempering time and an improvement of the separation of the endosperm and the seed coat, or of the bran and endosperm, respectively, and thus the flour yield, can be achieved. Exemplary enzymes are hemi-cellulases, cellulases, glucanases, laccases, proteases, amylases, and other enzymes which act on components of the plant seeds, in particular grain components.

Below, the invention will be illustrated more in detail by means of advantageous embodiments with reference to the drawings and following test examples. The advantageous further developments and embodiments represented here are each independent of each other and can be arbitrarily combined with each other, depending on what is required in the case of application.

In the drawings:

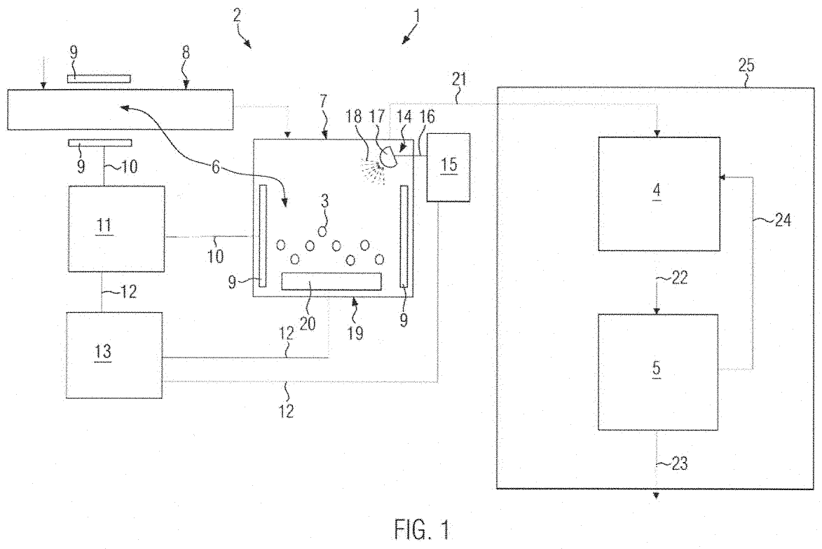

FIG. 1 shows a schematic representation of an exemplary embodiment of a system for disintegration of plant seeds according to the invention:

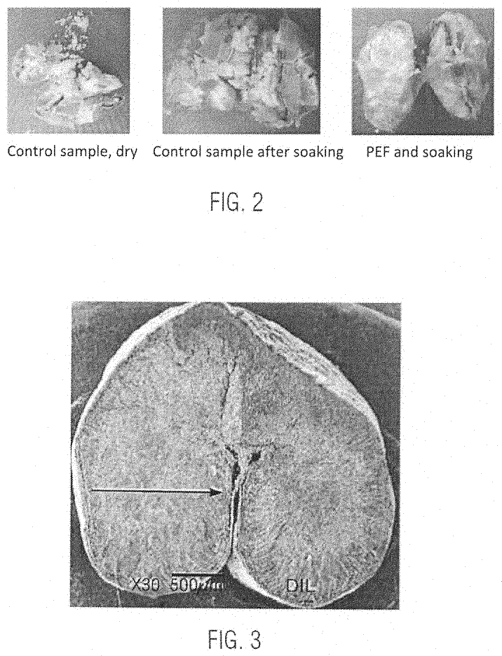

FIG. 2 shows photos of wheat grains after they have been squeezed in a texture analyzer: one control sample dry, one control sample after soaking, one sample after the treatment with an electrical field and soaking;

FIG. 3 shows an image for illustrating the characterization of the examining positions during an EDX analysis (energy-dispersive X-ray spectroscopy) for the determination of the distribution of oxygen in wheat grains;

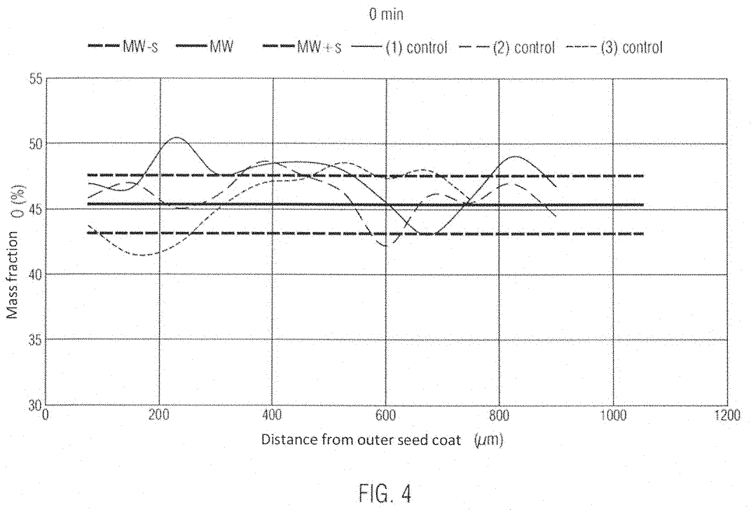

FIG. 4 shows a chart for illustrating the thorough moistening of untreated control samples directly at the beginning of thorough moistening;

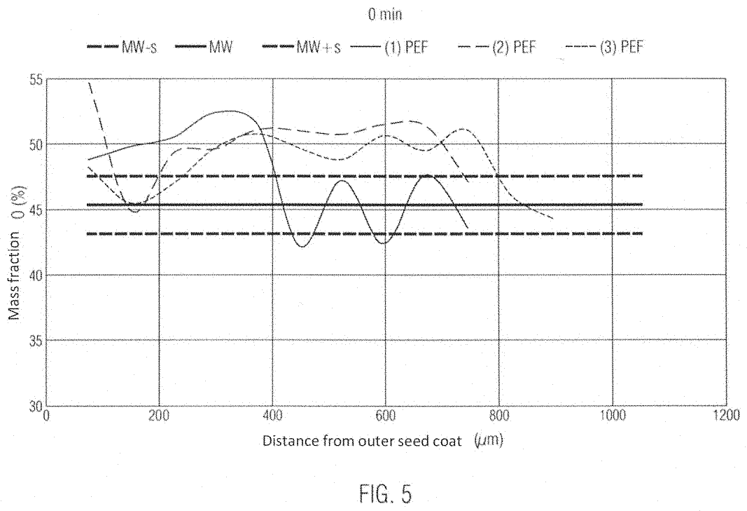

FIG. 5 shows a chart for illustrating the thorough moistening of grain samples conditioned by means of electrical fields directly at the beginning of thorough moistening;

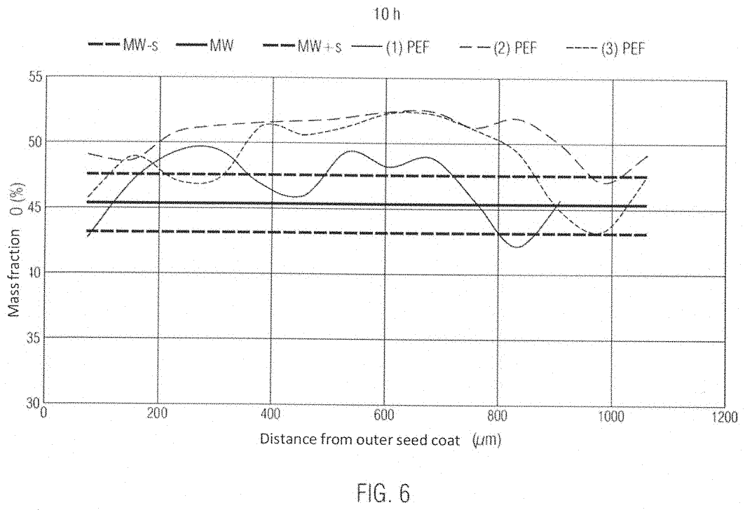

FIG. 6 shows a chart for illustrating the thorough moistening of grain samples conditioned by means of electrical fields after 10 hours of thorough moistening;

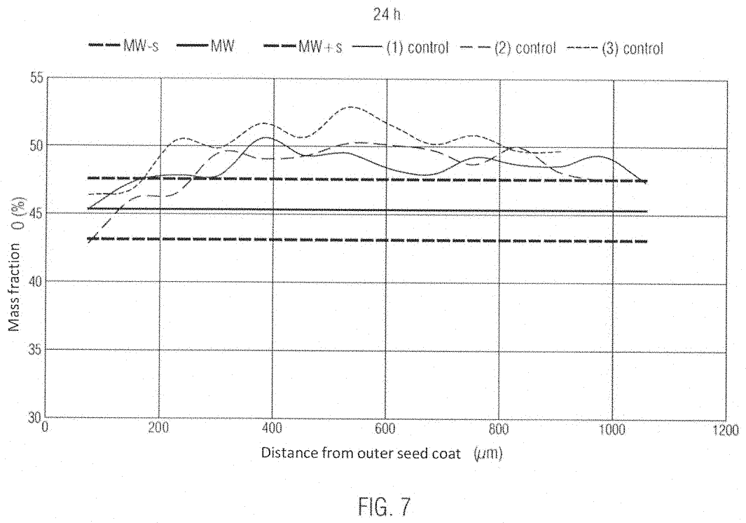

FIG. 7 shows a chart for illustrating the thorough moistening of untreated grain samples after 24 hours of thorough moistening; and

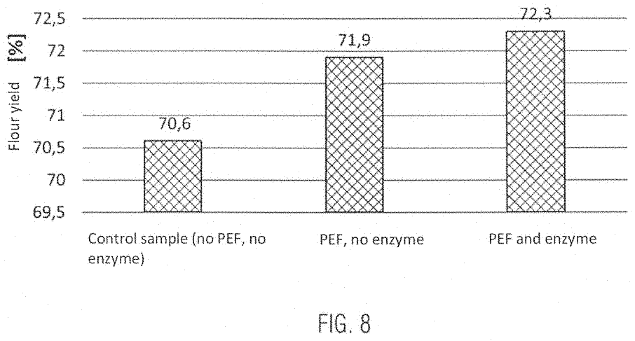

FIG. 8 shows a diagram for illustrating the better disintegration of plant seeds treated according to the invention.

Below, an exemplary method for conditioning plant seeds and an exemplary embodiment of a system for disintegration of plant seeds according to the present invention are illustrated with reference to FIG. 1.

The system 1 shown in FIG. 1 comprises a conditioning system 2 for conditioning plant seeds 3, a disintegration device 4 for disintegration of the conditioned plant seeds, and a separating device 5 for separating different fractions of the disintegrated plant seeds. The plant seeds 3 are schematically shown as circles in FIG. 1.

The conditioning system 2 comprises a capacitor 6 for generating an electrical field.

In the shown embodiment, the conditioning system comprises a tempering cell 7 and a metering device 8 by means of which plant seeds 3 are introduced into the tempering cell 7 which is symbolized by arrows.

In the shown embodiment, the capacitor 6 comprises two electrodes 9 which are connected to a voltage source 11 via energy lines 10. Two capacitors 6 are shown by way of example. The electrodes 9 of the one capacitor are arranged in the tempering cell 7 and can generate an electrical field in the tempering cell 7. The other capacitor 6 is provided in the region of the metering device 8 and is embodied such that plant seeds 3 can be exposed to an electrical field while passing the metering device 8. Of course, it is not obligatory to provide two capacitors, it would equally be possible to only provide the capacitor in the tempering cell 7 or only in the region of the metering device 8. For a better overview, only one energy line 10 to one of the two electrodes 9 of one capacitor 10 is drawn in.

In the shown embodiment, the electrodes 9 of a capacitor 6 are arranged in parallel with respect to each other which makes it possible to generate a homogeneous electrical field for a uniform sample treatment. However, other variants of the electrode arrangement are also conceivable, for example, a coaxial or colinear arrangement.

As a voltage source 11, a pulse generator, for example a high-voltage pulse generator, such as a Marx generator, can be employed by which electric pulses of a high-voltage in a kilovolt range and a short duration in a micro- to millisecond range can be generated.

To condition the plant seeds 3, for example, at least 10 electric pulses, preferably 10 to 200, and particularly preferred 30 to 50 electric pulses can be introduced. When an electrical field of 0.3 kV/cm to 10 kV/cm is applied, an energy input of more than 1 kJ/kg into the planted seeds 3 is achieved, for example of 1 kJ/kg to 20 kJ/kg, preferably of 8 kJ/kg to 12 kJ/kg.

Thereby, a controlled cell disruption of the plant seeds 3 can be achieved by electroporating the plant seeds 3, for example, by means of the pulsed electrical field.

The voltage source 11 is connected via a control line 12 to a central control unit 13 which controls the voltage source.

In the shown embodiment of FIG. 1, the conditioning system 8 furthermore includes a wetting device 14 for moistening the plant seeds 3. The wetting device 14 for moistening the plant seeds 3 is embodied in the tempering cell 7 by way of example. It includes a storage container 15 which is connected with a spraying device 17 disposed in the tempering cell 7 via a supply line 16. In the storage container 15, a moistening liquid 18 can be contained which can be transported via the supply line 16 to the spraying device 17 and there be distributed inside the tempering cell 7. The moistening liquid 18 can be added to the plant seeds 3 in this manner. The addition of the moistening liquid 18 can also be controlled via the central control unit 13 which is connected to the wetting device 14 via a further control line 12.

In the shown embodiment, a temperature and/or pressure controller 19 is furthermore provided in the tempering cell 7. The controller 19 can include, for example, a thermostat 20 which is arranged in the tempering cell 7 and by means of which the temperature in the tempering cell 7 can be controlled to a predetermined value. Control can be accomplished via the central control unit 13 which is connected to the thermostat 20 via a further control line 12 in the exemplary embodiment. Although this is not explicitly shown in FIG. 1, a pressure controller can furthermore be provided in the tempering cell 7 to adjust a predetermined pressure inside the tempering cell 7. A pH controller for controlling the pH value of the mixture of plant seeds 3 and moistening liquid 18 is also conceivable.

The exemplary conditioning system 2 of FIG. 1 permits to carry out the method for conditioning plant seeds according to the invention by exposing the plant seeds 3 to an electrical field. In the process, the plant seeds can be electroporated by means of an electrical field, and a defined cell disruption can be performed. During conditioning, the elasticity of the plant seeds 3 can be improved and adjusted to a predetermined range. Thus, the plant seeds, for example cereal grains, that means cereals such as wheat, can be prepared for a subsequent disintegration process, for example a grinding process, which positively influences the grinding behavior. The treatment is facilitated by means of an electrical field and accelerates, for example, the wetting and thorough moistening of the plant seeds 3 with the moistening liquid 18 and permits a purposeful influence on the elasticity of the plant seeds. This improves the breaking behavior of the plant seeds and reduces flour loss, which will be demonstrated below with reference to test examples, by improving the separation of the flour fraction from the bran.

In one embodiment, enzymes can be added to the wetting liquid which accelerate the wetting or thorough moistening, respectively, or positively influence the texture or structure of the plant seed 3 for subsequent disintegration in any other way. For example, hemi-cellulolytic enzymes can be employed, for example hemi-cellulases, cellulases, glucanases, laccases, proteases, amylases, which further reduce the required tempering time in the tempering cell 7 and optimize the separation of the seed coat from the seed kernel, for example the bran from the endosperm in case of cereals, and thus optimize the grinding yield. Hemi-cellulases include pentosanases, for example arabinases and xylanases (such as endo-1-4-β-xylanase, endo-1-3-β-xylanase, exo-1-4-β-xylanase, exo-1-3-β-xylanase or arabino-furanosidase, ferulic acid esterase, hydroxycinnamic acid esterase, acetic acid esterase). Further possible hemi-cellusases are hesosanases, such as e. g. ß-glucanase, galactase, or mannase.

Apart from the addition of enzymes via the moistening liquid 18, enzymes can also act on components of the plant seeds 3 in other ways. For example, by means of the electrical fields, endogenous enzymes can be released, in particular during electroporation, which, after a correspondingly long tempering time or by adjusting a temperature or pressure or pH value optimal for the enzyme activity, can be subsequently activated via temperature and/or pressure control.

By means of all these measures, the structure and texture of the plant seeds 3 can be conditioned and adapted to the desired disintegration properties of the plant seed 3. For example, in this manner, the elasticity of the seed coat and/or the elasticity of the seed grain can be adjusted very well.

The conditioned plant seeds 3 are supplied from the tempering cell 7 to the disintegration device 4 via a transfer line 21 after conditioning. In the disintegration device 4, the conditioned plant seeds are disintegrated, for which, for example, pressure disintegration, stroke disintegration, grate disintegration, cutting disintegration and/or impact disintegration, or peeling, can be employed. Disintegration machines include, for example, crushers, mills, peeling machines, or other mechanical disintegrators, such as vapor peelers.

The disintegrated plant seeds 3 are transferred from the disintegration device 4 into the separating device 5 via a transfer point 22. In the separating device 5, different fractions of the disintegrated plant seeds are separated from each other. For example, the coat of peeled plant seeds, such as e. g. peeled chickpeas, rice and soya beans, can be separated. Possible methods for separating the fractions are, for example, screening or classifying. In cereal mills, classifiers are often employed by means of which solids can be classified according to defined criteria, such as particle size, density, inertia, and the floating or lamination behavior, and thus different fractions (that means fractions of different particle properties) can be separated from one another.

The fraction of the plant seeds desired by disintegration is finally guided out from the separating device via the outlet 23. The fraction which does not yet have the desired properties can be returned to the disintegration device 4 via a return line according to the exemplary embodiment, and be disintegrated again. Of course, instead of returning it, this fraction can also be transferred to a further, second disintegration device (not shown).

The product guidance of disintegration and separation is carried out in cereal mills by grinding in roll mills and subsequent classification. In the process, a run through a disintegration device 4 and a subsequent separating device 5 is referred to as passage. In the exemplary embodiment of FIG. 1, thus an exemplary disintegration passage 25 with a disintegration step carried out in a disintegration device 4 and a subsequent separation of different fractions in a separating device 5 is shown.

Below, by means of some concrete test results, exemplary embodiments of the method according to the invention and the advantages achieved thereby are represented.

For the treatment of the cereals with pulsed electrical fields (PEF), the grains were covered with water. A ratio of 100 g (cereals):800 g (water) was selected. However, any other ratio could have been selected in which it can be ensured that the cereal is completely wetted. The treatment with PEF was accomplished in a batch system with a treatment cell having a capacity of 900 ml. The applied field strength was 3 kV/cm, the energy input 10 kJ/kg. Subsequently, the grains were transferred to a screen and separated from the treatment water. Already directly after the PEF treatment (in which the grains were made with water only for 2 minutes and thus clearly shorter than the usual hour), a proportion of approximately 18 g of water remained on the grains as a surface wetting.

After the treatment, a determination of the texture properties was done by means of a texture analyzer with respect to the compression and cutting forces. After a PEF treatment and soaking, an increase of the maximal compression force of 34.94 kg for untreated samples to 42.96 kg was determined. The fracture behavior of the PEF-treated samples thus advantageously showed to be more elastic and less brittle than that of untreated control samples. The seed coat of PEF-treated grains thus falls apart into fewer parts, and therefore, the endosperm can be more easily separated than in the dry or the soaked sample, which, however, was not treated by PEF (see FIG. 2).

The analysis of the water distribution in the grain was carried out directly after treatment, after 10 and 30 minutes, and after 1, 2, 4, 10 and 24 hours. A control sample was analyzed in parallel with the same method. By means of an EDX analysis, the distribution of the elements in grains was determined, and the penetration of water was characterized by the increase in the proportion of oxygen. The examination positions are represented in FIG. 3.

The wheat grains treated by means of PEF had, as shown in FIGS. 4 to 7, a better water distribution already at the beginning of the thorough moistening than the untreated samples, which can be identified by the course of the line above the mean value (MW) plus standard deviation (S). Already after 10 hours, the PEF-treated grains had a uniform thorough moistening of the endosperm optimal for grinding, while this was only reached after 24 hours in untreated samples.

The loosening of the endosperm structure and the loosening of the connection between the aleurone layer and the flour kernel caused thereby permitted the shortening of the tempering time with a comparable flour yield.

Below, a possible embodiment of the invention is represented by way of example by means of a test example.

For the tests, wheat (Triticum aestivum L., winter bread wheat. Class Butaro. August 2017) of one batch was filled into the treatment container of a discontinuous PEF system in portions of 400 g. Subsequently, 300 ml of tap water (optionally with the enzyme xylanase dissolved therein, 10-100 ppm, based on cereal) were poured on it and the container was PEF-treated for 20 s. 31 pulses with 30 kV and 450 J each were emitted to the grains, the specific energy input was 20 kJ/kg per batch. After a contact time with the water of altogether 60 s, the water was centrifugated off. The humidity content of the grains was between 15.2 and 16.4% after centrifugation. Per adjustment, 8 tests were made to obtain a sufficient cereal amount for grinding in a laboratory mill (Bihler MLU).

The flour yield (extraction rate) was adjusted to an ash value of 0.63. The ash content is a decisive quality feature and correlates with the extraction rate. The extraction rate is determined from the ratio of the parts by weight of the flour to the total weight in percent. This is an index of the efficiency of the grinding process by comparing the weight of the overall output with the starting weight. In the tests, the parts by weight of the passage flours and the bran centrifugation flours were added and calculated in relation to the wheat weighed in.

Formula for the Extraction Rate:

$$E = \frac{EP + EK}{EG} * 100$$

E=extraction rate [%];
EP=extraction of passage flour [g];
EK=extraction of bran centrifugation flour [g];
EG=total initial weight [g]

Moreover, the extraction rate with an adapted ash content was employed as a parameter. It was calculated by a formula which fixes the ash percentage since this is a quality feature and has an influence on the extraction rate.

Formula for the Adapted Extraction Rate:

$$EP * AP + AEK * AK = EG * AG$$

$$EG = EP + AEK$$

$$AEK = \frac{EP * ( AG - AP )}{AK - AG}$$

$$AE = \frac{AEK + EP}{EG}$$

EP=extraction of passage flour [g]
AEK=adapted extraction of bran centrfugation flour [f]
EG=total initial weight [g]
AP=ash passage flour [% in dry matter]
AK=ash bran centrifugation flour [% in dry matter]
AG=ash desired percentage
AE=adapted extraction value

FIG. 8 shows that the conditioning with an electrical field, both alone and in combination with the enzyme xylanase, surprisingly increases the flour yield. Compared to the untreated reference, the additional yield was improved by 1.4% by PEF, and by 1.8% by the combination of PEF and enzyme.

### REFERENCE NUMERALS

1 system
2 conditioning system
3 plant seeds
4 disintegration device
5 separating device
6 capacitor
7 tempering cell
8 metering device
9 electrodes
10 energy line
11 voltage source
12 control line
13 control unit
14 wetting device
15 storage container
16 supply line
17 spraying device
18 moistening liquid
19 temperature and/or pressure controller
20 thermostat
21 transfer line
22 transfer point
23 output
24 return line
25 passage

1. Method for conditioning plant seeds (3) for disintegration, in particular for influencing the elasticity of the plant seeds (3), characterized in that the plant seeds (3) are exposed to an electrical field.

2. Method according to claim 1, wherein the plant seeds (3) are electroporated by means of the electrical field.

3. Method according to claim 1, wherein in the treatment with the electrical field, an energy input of 1 kJ/kg to 20 kJ/kg, preferably of 8 kJ/kg to 12 kJ/kg, into the plant seeds (3) is accomplished.

4. Method according to claim 1, wherein the plant seeds (3) are exposed to an electrical field strength of 0.3 kV/cm to 10 kV/cm, preferably of 2 kV/cm to 4 kV/cm.

5. Method according to claim 1, wherein the plant seeds (3) are exposed to a pulsed electrical field.

6. Method according claim 1, wherein the elasticity of the plant seeds (3) is improved during conditioning compared to non-conditioned plant seeds.

7. Method according to claim 6, wherein the elasticity of the seed coat and/or the elasticity of the seed kernel, in particular the endosperm, is modified during conditioning.

8. Method according to claim 1, wherein a moistening liquid (18) is added to the plant seeds (3) before or while they are exposed to the electrical field.

9. Method according to claim 1, wherein the plant seeds (3) are exposed to a predetermined pressure and/or a predetermined temperature.

10. Method according to claim 1, wherein enzymes act on components of the plant seeds (3).

11. Method according to claim 10, wherein the enzymes are selected from the group of hemi-cellulases, cellulases, glucanases, laccases, proteases und amylases.

12. System (1) for disintegration of plant seeds (3), comprising a conditioning system (2) for conditioning the plant seeds (3), a disintegration device (4) for disintegration of the conditioned plant seeds (3), and a separating device (5) for separating different fractions of the disintegrated plant seeds, wherein the conditioning system (2) has a capacitor (6) for generating an electrical field that acts on the plant seeds (3).

13. System (1) according to claim 12, wherein the conditioning system (2) has a wetting device (14) for moistening the plant seeds (3) and/or a tempering cell (7).

14. System (1) according to claim 12, wherein the conditioning system (2) has a temperature and/or pressure controller (19).

15. System (1) according to claim 12, wherein the capacitor (6) comprises at least two electrodes (9) which are connected to a pulse generator as a voltage source (11).

16. Method according to claim 2, wherein in the treatment with the electrical field, an energy input of 1 kJ/kg to 20 kJ/kg, preferably of 8 kJ/kg to 12 kJ/kg, into the plant seeds (3) is accomplished.

17. Method according to claim 2, wherein the plant seeds (3) are exposed to an electrical field strength of 0.3 kV/cm to 10 kV/cm, preferably of 2 kV/cm to 4 kV/cm.

18. Method according to claim 2, wherein the plant seeds (3) are exposed to a pulsed electrical field.

19. System (1) according to claim 13, wherein the conditioning system (2) has a temperature and/or pressure controller (19).

20. System (1) according to claim 13, wherein the capacitor (6) comprises at least two electrodes (9) which are connected to a pulse generator as a voltage source (11).
